(19) United States
(12) Patent Application Publication
(10) Pub. No.: US 2018/0079492 A1
(43) Pub. Date: Mar. 22, 2018

(54) Flow control device, flow profile body and flow influencing method with acoustic wave generation

(71) Applicants: Airbus Defence and Space GmbH, Taufkirchen (DE); Universität des Saarlandes, Saarbrucken (DE)

(72) Inventors: Helmut Seidel, Starnberg (DE); Dara Feili, Saarbruecken (DE); Karin Bauer, Oberhaching (DE); Christian Kiefer, Saarbruecken (DE)

(21) Appl. No.: 15/813,818

(22) Filed: Nov. 15, 2017

Related U.S. Application Data
(63) Continuation of application No. PCT/EP2016/059800, filed on May 2, 2016.

(30) Foreign Application Priority Data
May 15, 2015 (DE) 102015107626.8

(51) Int. Cl. B64C 23/00; B64D 15/16; H04R 1/02; H04R 1/40

(52) U.S. Cl. CPC B64C 23/005; B64D 15/163; B64C 23/06; H04R 1/403; B64C 2230/02; H04R 1/028

(57) ABSTRACT

For adaptively influencing a flow with little intrusion into the surface, a flow control device is provided to influence the flow of a fluid medium on a fluid-dynamical surface of a fluid-dynamical profile body. An acoustic wave generating device is used to generate a standing acoustic wave with locally defined antinodes and nodes, and/or a sonic pulse is focused in a locally defined manner.

### CROSS-REFERENCES TO RELATED APPLICATIONS

This application is a continuation of International Application PCT/EP2016/059800 filed May 2, 2016, designating the United States and published on Nov. 24, 2016 as WO 2016/184676. This application also claims the benefit of the German patent application No. 10 2015 107 626.8 filed on May 15, 2015. The entire disclosures of the above are incorporated herein by way of reference.

### BACKGROUND OF THE INVENTION

The invention relates to a flow control device for influencing a fluid flow on a fluid-dynamical surface of a fluid-dynamical profile body. The invention also relates to a fluid-dynamical profile body having a fluid-dynamical surface flowed against and/or around by fluid flow when in operation. The invention further relates to a flow control method for influencing a flow on a fluid-dynamical surface of a fluid-dynamical profile body. The invention still further relates to advantageous uses of novel flow influencing techniques on such fluid-dynamical surfaces.

In particular, the invention relates to an actuator system for influencing flows in order to reduce or increase drag.

For the technological background and for better understanding the invention and the advantageous embodiments thereof, reference is made to the following literature:
[1] http:/www.die-vier-liter-flieger.de/de/die-vier-liter-flieger/
[2] https://de.wikipedia.org/wiki/Vestas_V164-8.0
[3] http://www.wind-energie.de/infocenter/technik/funktionsweise/aerodynamik-rotorblaetter
[4] http://daten.didaktikchemie.uni-bayreuth.de/umat/wellen_mechanisch/wellen_mechanisch.htm
[5] http://dl.acm.org/citation.cfm?doid=2601118
[6] http://www-brs.ub.ruhr-uni-bochum.de/netahtml/HSS/Diss/SprynchakVitaliy/diss.pdf
[7] R. Tuckermann, S. Bauerecker—Wie akustische Kaltgasfallen wirken. “Tannenbäume” im stehenden Ultraschallfeld; in Chemie in unserer Zeit, Volume 42, Issue 6, pages 402-407, Dezember 2008
[8] http://www.olympus-ims.com/en/ndt-tutorials/transducers/inside/
[9] http://scitation.aip.org/content/aip/journal/pof2/19/4/10.1063/1.2717527
[10] http://de.wikipedia.org/wiki/Absaugen/Ausblasen_der_Grenzschicht
[11] L. Duan, M. M. Choudhari—Effects of Riblets on Skin Friction in High-Speed Turbulent Boundary Layers; 50th AIAA Aerospace Sciences Meeting including the New Horizons Forum and Aerospace Exposition, Jan. 9-12, 2012, Nashville, Tenn.
[12] M. I. Mukut, H. Mizunuma, O Hiromichi—Flow Separation Control Using Plasma Vortex Generator; 10th International Conference on Mechanical Engineering, ICME 2013; Procedia Engineering 90 (2014) 232-237; http://www.sciencedirect.com/science/article/pii/S1877705814029713/pdf?md5=0 10ad92800bfdcd9a359b2c2dc8f2a1e&pid=1-s2.0-S1877705814029713-main.pdf
[13] http://journals.cambridge.org/action/displayAbstract?fromPage=online
[14] DE 10 2008 006 832 A1
[15] DE 10 2008 017 963A1
[16] DE10 2008 022 504 B4
[17] EP 0 955 235 B1
[18] EP 2 272 753 A1
[19] WO 2014 023 951 A1
[20] EP 2 223 853 A1
[21] http://de.wikipedia.org/wiki/Profil_(Strömungslehre)
[22] DE 10 2008 006 831 A1
[23] DE102008035423A1
[24] DE 10 2013 013 148 B3

A passenger airplane consumes about 3 liters of fuel per person per 100 km. Today, the fuel accounts for one third of the operating costs. Seen from an environmental point of view, the contribution of air travel to the worldwide CO2 emissions is 2.42%, see [1].

In this context, drag plays a decisive role. Due to the generally inevitable friction on surfaces, a so-called boundary layer is formed on aircraft surfaces as a result of passing air and extends in a laminar fashion over the entire surface at a low Reynolds number. If the Reynolds number is higher, the laminar flow cannot be completely maintained so that this laminar flow collapses in the flow direction and continues in a turbulent fashion—compare FIG. 1. In fluid dynamics, the change from a laminar to a turbulent flow is also referred to as transition. This region (turbulent flow boundary layer) is characterized by a strong vortex formation and a chaotic flow behavior so that a clearly higher drag is produced.

This problem plays a part also in wind power plants for example. Current wind power plants (e.g., Vestas V164-8.0, see [2]) with rotor diameters of 164 m reach blade tip speeds of up to 370 km/h. Aerodynamic losses, i.e., friction on the profile surfaces (so-called profile losses) and pressure equalization at the blade tip (so-called tip losses), reduce the maximum rotor efficiency. Theoretically, the maximum efficiency is approx. 59%, in practice, however, current wind energy rotors reach an efficiency level of approx. 50%, see [3].

A vast number of different approaches have already been proposed, but none of them has been successful so far:

riblets: similar to sharkskin, miniaturized ribs/walls are applied to the surface (in the range of millimeters) and are intended to prevent a transverse flow of the stream, see, e.g., [11]

turbulator (vortex generator): by providing a small surface defect, the laminar flow is transferred to a turbulent flow in a targeted manner to delay stall (sudden decrease in lift), see, e.g., [14], [16], [18]

sucking off the boundary layer: the existing boundary layer is sucked off and into the interior through small openings, see, e.g., [10], [17], [19]

blowing out into the boundary layer (synthetic jets): a jet is blown into the boundary layer at a defined frequency using nozzles, whereby the separated flow again applies against the surface, see, e.g., [10], [15]

surface waves: a wave is generated on the surface by means of actuators (e.g., piezoelectric actuators), the wave having a positive influence on and delaying the laminar-turbulent transition, see, e.g., [13], [18]

plasma vortex generator: a plasma can be created by means of electrodes attached on and below the surface, whereby smaller air vortices are produced on the surface; these have a direct effect on the boundary layer, see, e.g., [12].

[20] and [21] describe examples of fluid-dynamical profile bodies to which the invention can be applied.

[22], [23] and [24] describe detectors or sensors for detecting characteristics and/or parameters of a to-be-influenced flow.

Many of the above-described approaches present the current state of research and have not yet been sufficiently tried and tested. Some of these approaches look promising in their effect and may have sufficient potential, but also have disadvantages:

An excessive intrusion into the surface, e.g., in the form of bores, incisions, protruding objects, causes an effect—possibly also negative—on the flow so that the drag may even increase. In addition, such “surface defects” are highly susceptible to pollution, which may lead to a failure of the actuators.

While riblets offer a drag reduction of approx. 2%, as has been shown by a field test with Airbus aircraft and a 3M riblet tape, these are limited to a particular airspeed due to the non-scalable spacings and size of the riblets.

Plasma vortex generators require high voltages and much power for maintaining the plasma that has been created.

### SUMMARY OF THE INVENTION

It is an object of the present invention to provide an improved possibility for influencing the flow on fluid-dynamically effective surfaces. In addition, the aim is to show further advantageous uses of the flow influencing technologies as employed for that purpose.

To achieve this object, there are proposed a flow control device, a flow control method, a fluid-dynamical profile body, as well as uses of acoustic waves.

In a first aspect, the invention provides a flow control device for influencing a fluid flow on a fluid-dynamical surface of a fluid-dynamical profile body, an acoustic wave generating means to generate a standing acoustic wave with locally defined antinodes and nodes, and/or a sonic pulse focused in a locally defined manner.

Preferably, the acoustic wave generating means comprises at least one sound transducer to generate a primary acoustic wave having a propagation direction which with its main directional component runs parallel to the surface and perpendicular to the flow, and a sound reflecting means for back-reflecting the primary acoustic wave for the purpose of generating the standing acoustic wave.

Preferably, the acoustic wave generating means comprises at least a first sound transducer to generate a first acoustic wave having a propagation direction which, with its main directional component, runs parallel to the surface and perpendicular to the flow, and a second sound transducer to generate a second acoustic wave having a propagation direction opposed to the propagation direction of the first acoustic wave, to generate the standing acoustic wave by a superposition of the first and the second acoustic waves.

Preferably, the acoustic wave generating means comprises an array of sound transducers arranged at regular intervals on the surface forming the surface and configured to generate the standing acoustic wave with locally defined antinodes and nodes, and/or the locally focused sonic pulse.

Preferably, the acoustic wave generating means comprises an arrangement of at least one sound transducer or several sound transducers and at least one acoustic lens.

Preferably, the acoustic wave generating means is configured to generate the standing acoustic wave in such a way that nodes and antinodes extend longitudinally along the direction of flow.

Preferably, the acoustic wave generating means is configured to generate the standing acoustic wave in such a way that nodes and antinodes alternate in a transverse direction to the direction of flow.

Preferably, the acoustic wave generating means is configured to generate the standing acoustic wave in such a way that locations of nodes and/or antinodes run straight.

Preferably, the acoustic wave generating means is configured to generate the standing acoustic wave in such a way that locations of nodes and/or antinodes run in a tapering and/or triangular fashion.

Preferably, the acoustic wave generating means is configured to generate the standing acoustic wave in such a way that locations of nodes and/or antinodes run in a wave-like fashion.

Preferably, the acoustic wave generating means is configured to generate the standing acoustic wave in such a way that locations of nodes and/or antinodes run parallel.

Preferably, the acoustic wave generating means is configured in such a way that the acoustic wave is generated or modified as a function of parameters of the to-be-influenced flow.

In particular, the flow control device is configured in a manner such as to detect a characteristic or a parameter of the to-be-influenced flow and to drive the acoustic wave generating means in response to the detected parameters. Preferably, in this course, the intensity—e.g., the sound level—and the local distribution of the standing acoustic wave are modified and adjusted to the actual conditions.

For the detection of characteristics of the flow, there can be employed, for instance, one or more of the detectors known from [22], [23] and [24]. In a particularly preferred embodiment, sound transducers are not only used for sound generation but also for the detection of at least one characteristic or one parameter of the flow.

The sound transducers are connected, for example, to a control device and are supplied with controlling energy—e.g., an electric voltage—in order to generate the acoustic waves. Conversely, most of the sound transducers are capable of converting corresponding pressure fluctuations to a different form of energy—e.g., to an electric voltage. The control device can be configured in such a way that in the receiving mode it correspondingly receives signals from the sound transducer for drawing conclusions on the flow conditions and for driving the sound transducer in a different manner if necessary.

In a further aspect, the invention provides a fluid-dynamical profile body having a fluid-dynamical surface against and/or around which a fluid flows when in operation, comprising an acoustic wave generating means to generate a standing acoustic wave with antinodes and nodes arranged in a locally defined manner on the surface, and/or a sonic pulse focused in a locally defined manner.

Preferably, the fluid-dynamical profile body comprises a flow control device in accordance with one or more of the above-described configurations.

For example, the fluid-dynamical profile body can be configured as:
a flow profile of an aircraft or
a wing or tail unit body of an airplane or
an engine inlet body of a vehicle or aircraft or
a rotor blade or propeller blade of an aircraft or windmill.

Further embodiments of the invention relate to the application of the flow influencing techniques herein presented by means of standing acoustic waves and/or acoustic waves focused in a targeted manner to other vehicles such as land vehicles or water vehicles and to any other situation in which it is desired to influence the flow on flowed-around fluid-dynamical surfaces and bodies in order to avoid or delay for instance a transition from a laminar to a turbulent flow.

According to a further aspect, the invention relates to a flow control method for influencing a flow at a fluid-dynamical surface of a fluid-dynamical profile body, comprising: influencing the flow by means of acoustic waves generated on the surface in a locally defined manner—particularly in the flowed-around fluid medium.

A preferred embodiment of the method is characterized by

a) generating at least one standing acoustic wave and/or

b) focusing a sonic pulse on a to-be-influenced flow area.

Preferably, step a) includes the step of:

generating the standing acoustic wave with nodes and/or antinodes longitudinally extending along the direction of flow.

Preferably, step a) includes the step of:

generating the standing acoustic wave with nodes and/or antinodes alternating in a transverse direction to the direction of flow.

Preferably, step a) includes the step of:

generating the standing acoustic wave with nodes and/or antinodes running straight.

Preferably, step a) includes the step of:

generating the standing acoustic wave with nodes and/or antinodes running in a tapering and/or triangular fashion.

Preferably, step a) includes the step of:

generating the standing acoustic wave with nodes and/or antinodes running in a wave-like manner.

Preferably, step a) includes the step of:

generating the standing acoustic wave with nodes and/or antinodes running parallel.

A further preferred embodiment of the flow control method is characterized by preventing or delaying the transition of a laminar flow stream to a turbulent condition by using a standing acoustic wave as an obstacle to and/or a guide for the flow stream and/or as a vortex generator.

A further preferred embodiment of the flow control method is characterized by modifying the acoustic wave generation in response to parameters of the to-be-influenced flow.

A further preferred embodiment of the flow control method is characterized by detecting at least one parameter of the to-be-influenced flow and by generating the acoustic waves in response to the detected parameter.

A further preferred embodiment of the flow control method is characterized by using at least one sound transducer for producing the acoustic wave and as a detector for detecting a characteristic or parameter of the to-be-influenced flow.

A further preferred embodiment of the flow control method is implemented using the flow control device in accordance with one or more of the above-described embodiments. A further preferred embodiment of the flow control method is implemented on a fluid-dynamical profile body in accordance with one or more of the above-described embodiments.

In a further aspect, the invention relates to the use of a standing acoustic wave and/or a focused sonic pulse in a fluid medium for influencing a flow of the fluid medium on a fluid-dynamical surface.

A further invention that is based on the same idea of using standing acoustic waves and/or acoustic waves that are locally focused in a targeted manner in the region of the surface of fluid-dynamical profile bodies relates to an anti-icing device for preventing ice formation on a flowed-around profile body, the device comprising an acoustic wave generating means to generate a standing acoustic wave with antinodes and nodes arranged on the surface in a locally defined manner, and/or a sonic pulse focused in a locally defined manner.

### BRIEF DESCRIPTION OF THE DRAWINGS

In the following, the invention will be described in more detail with reference to the attached drawings.

FIG. 1 is a schematic illustration of a transition of a boundary layer on a fluid-dynamical profile body from a laminar to a turbulent flow to show one of the problems that can be solved by embodiments of the present invention; shown therein is the boundary layer, laminar (to the left) and turbulent (to the right);

FIG. 2 is a first embodiment of a fluid-dynamical body with a first embodiment of a flow control device that comprises a first embodiment of an acoustic wave generating means;

FIGS. 3A-3D are diagrams for illustrating the operation of the acoustic wave generating means and the flow control device using the same;

FIGS. 4A-4D are photographs of a visualization of standing acoustic waves as the same can be employed in embodiments of the flow control device for influencing a flow on a fluid-dynamical body;

FIGS. 5A-5F show six different further embodiments of the acoustic wave generating means using different arrays of sound transducers—in the following also referred to as phased array transducers;

FIG. 6 is a diagram illustrating the generation of a standing acoustic wave using the phased array transducer according to one of the representations shown in FIG. 5;

FIG. 7 is a second embodiment of a fluid-dynamical profile body with a second embodiment of a flow control device comprising acoustic wave generating means of the kind shown in FIGS. 5A-5F and FIG. 6 with phase array transducers;

FIGS. 8A-8C show possible configurations of standing acoustic waves for influencing the flow in a flow control device, for example, in accordance with FIG. 7;

### DETAILED DESCRIPTION OF THE PREFERRED EMBODIMENTS

FIG. 1 shows one example of a fluid-dynamical surface 10 against which a flow 12 of a fluid medium 14 flows, such as air, for example. The surface 10 is, for example, a surface of a wing 16 of a passenger airplane 18 moving through the air.

In this context, drag plays an important part. Due to the friction on surfaces, which is generally inevitable, a so-called boundary layer 20 is produced on aircraft surfaces as a result of air moving in a laminar flow over the entire surface 10 at a low Reynolds number. At a higher Reynolds number, it is not possible to completely maintain that laminar flow 22, so this flow collapses in the direction of flow 24 and continues in a turbulent fashion—turbulent flow 26. In fluid dynamics, the change from a laminar flow 22 to a turbulent flow 26 is also referred to as a transition and is shown in FIG. 1 as a transition region 28. The region of turbulent flow 26 is characterized by a strong vortex formation and by a chaotic flow behavior, which cause a clearly higher drag. Below the turbulent flow 26, there is a laminar sub-layer 30.

To avoid or delay the transition from a laminar flow 22 to a turbulent flow 24, the generation of so-called riblets have shown to be useful measures in the prior art, these riblets being, for instance, rib-like obstacle structures that are oriented in the direction of flow 24. Such riblets are formed, for example, by structures that are adhered and are correspondingly fixed in place.

Flow control devices 32 with which similar effects as those of riblets can be achieved, but which require less intrusion into the surface shape of the fluid-dynamical surface 10 and which can be adjusted to changing flow conditions, are described in the following.

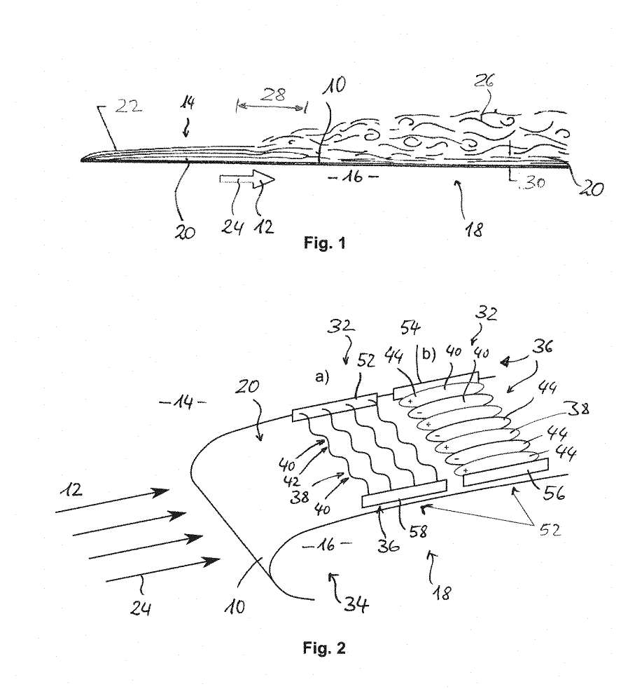

FIG. 2 shows an exemplary embodiment of a fluid-dynamical profile body 34 where such a fluid-dynamically effective surface 10 is flowed against by a flow 12 of the fluid medium. The profile body 34 is, for example, an airfoil or wing 16 of an aircraft 34, e.g., a passenger airplane 18. Further examples of the profile body 34 are tail unit bodies, fuselage portions or engine parts such as engine inlets of aircraft, or propeller blades or rotor blades of aircraft, like airplanes or helicopters. Another example of the profile body are the rotor blades of windmills. For further details concerning such profile bodies, please refer to [1], [2], [3], [20] and [21] of the cited literature.

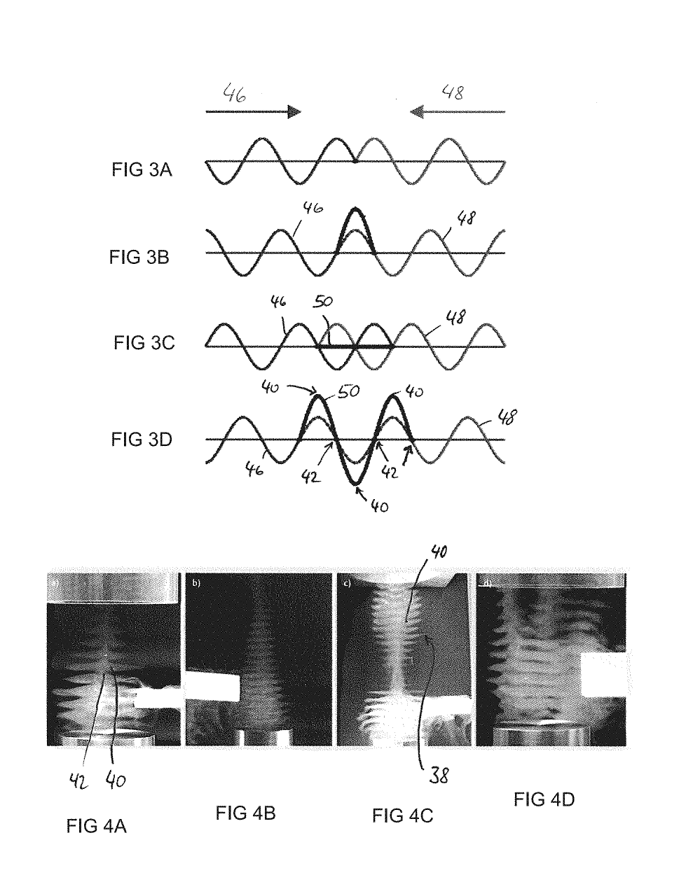

However, instead of rigid riblets, the flow control device 32 comprises an acoustic wave generating means 36 capable of generating a three-dimensional standing acoustic wave 38 in the fluid medium 14 in the boundary layer 20. Such a standing acoustic wave 38 with antinodes 40 and nodes 42 constitutes a kind of “virtual riblets” 44 acting like physically present riblets. This will be more clearly explained with reference to FIGS. 3A-3D and FIGS. 4A-4D.

FIGS. 3A-3D show the superposition of waves 46, 48 and a resulting standing wave 50, see [4] and also see Wikipedia: http://de.wikipedia.org/wiki/Stehende_Welle. In the FIGS. 3A to 3D, a wave 46 traveling to the right is superimposed by a wave 48 traveling to the left.

By the superposition of two waves 46, 48 of equal frequency, a standing wave can be produced. If two waves 46, 48—in FIG. 3A, here with equal amplitude—meet midway, this will lead to an interference by superposition.

If the waves 46, 48 each propagate by a quarter wavelength (=¼λ), the waves will have shifted to each other by one half of the wavelength in total, see FIG. 3B. At this point of time, the waves 46, 48 are in phase, which leads to a constructive interference.

If each of the waves again propagates by ¼λ, as shown in FIG. 3C, the waves are in opposite phase with destructive interference. The amplitude of the resulting wave 50 is therefore equal to zero.

If each of the waves again propagates by ¼λ, the waves are again in phase. It follows again a constructive interference with a corresponding amplitude of the resulting wave, see FIG. 3D. Accordingly, the standing maxima or minima are produced each time at the same point, whereby the standing wave 50 is produced, compare FIG. 3B with FIG. 3D.

In the acoustic wave generating means 36, audible sound in the higher frequency range and particularly ultrasound with frequencies above the audible frequency range of a human, is produced by sound generators or sound transducers (also referred to as transducers) by means of the (inverse) piezoelectric effect for example. In this case, a high-frequency electric alternating voltage causes a piezoelectric material such as lead zirconate titanate (PZT) to vibrate, these vibrations causing pressure fluctuations and consequently sound in a compressible medium 14 like air.

According to the principle of the standing wave 50, lightweight particles can be kept suspended during acoustic levitation, for example. As a result of alternating pressure differences, small flows are produced in a circular pattern for example and can therefore exert a force on smaller particles. This so-called acoustic force can be utilized for correspondingly holding particles captive, compare FIGS. 4A-D. For further explanation and details, please see references [5], [6] and [7], incorporated herein by reference.

This effect can eventually be used also for flow control. For this purpose, two opposing transducers (or one transducer with an opposing reflector)—first sound transducer 54 and second sound transducer 56 or sound transducer 52 and reflector 58—are vertically attached close the surface—the surface 10—(e.g., perpendicular to the surface), which generate a two-dimensional stand acoustic wave there between, hence alternating pressure points, compare FIG. 2a. If a corresponding number of such two-dimensional standing waves are arranged one behind the other with the same orientation, an elongate “pressure wall” 60 is produced—the local distribution of an antinode of a three-dimensional standing acoustic wave 38 being indicated with “+” for a positive amplitude and with “−” for a negative amplitude—which pressure wall is hereinafter referred to as a “virtual” riblet 44, see FIG. 2b. In the event of influencing the turbulence, the virtual riblets 44 are preferably aligned in a manner such as to run parallel to the direction of flow.

Accordingly, the embodiment of the flow control device 32 shown in FIG. 2 comprises an acoustic wave generating means 36 that is configured for forming a standing acoustic wave 38 whose antinodes present a defined local distribution for influencing the flow.

In this case, there is provided an arrangement of at least one sound transducer 52 and one reflector 58 or an arrangement of at least a first sound transducer 54 and a second sound transducer 56.

To the sound transducers 52, 56, 54 a control device (not further illustrated) is connected, which supplies the sound transducers with an adjustable alternating voltage to generate a three-dimensional standing acoustic wave 38 and hence the riblets that are arranged and distributed in a locally defined manner.

By an appropriate control, the number, position, orientation and intensity of the virtual riblets 44 (of the antinodes 40) can be altered in a targeted manner and adjusted to current conditions and characteristics of the flow 12.

The targeted change and alignment of the position of antinodes of standing acoustic waves is known and is described, for example, in [5], [6] and [7] for different applications. The FIGS. 4A-4D show different locally defined three-dimensional standing acoustic waves generated in a targeted manner, taking acoustic levitation as an example. FIGS. 4A-4D shows the visualization of the acoustic resonance patterns of the acoustic levitation using cold ice aerosol, see [7].

FIG. 2 shows the use of this technique of standing acoustic waves for flow control. By providing the virtual riblets 44, transverse flows within the boundary layer 20 are prevented so that an extended laminar flow 22 is produced. By maintaining the low-resistance laminar flow 22 for an extended period and by deferring the transition to the turbulent flow 28, drag that is produced in total is generally lower.

FIG. 2 shows the formation of riblets 44 by means of transducers that are arranged vertically.

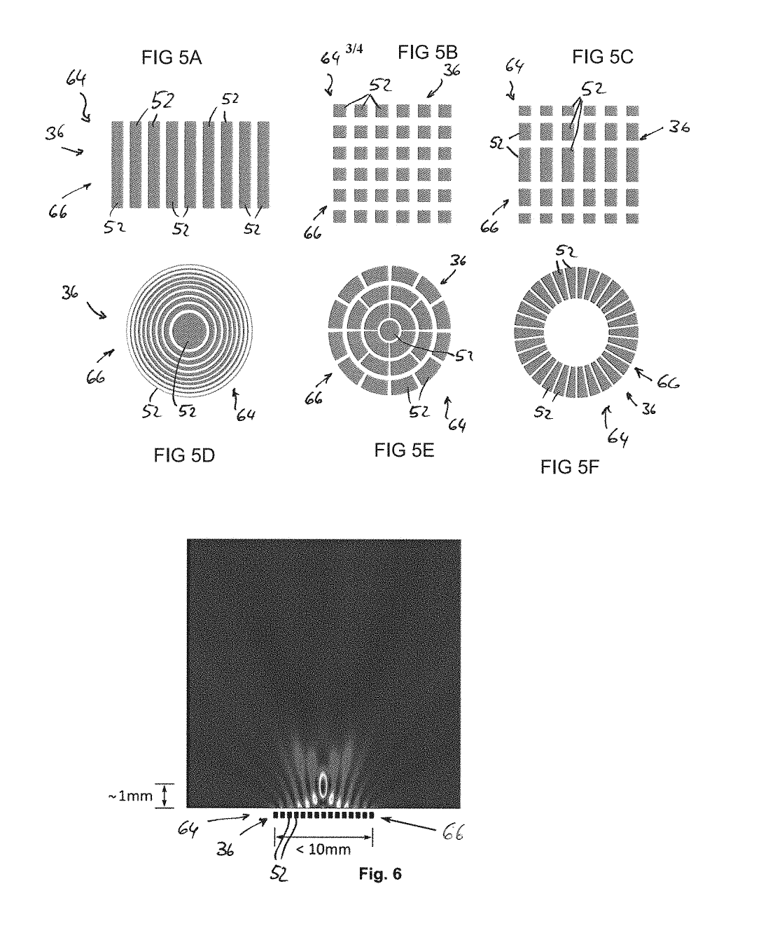

In the following, reference is made to FIGS. 5A-5F showing further embodiments of the acoustic wave generating means 36 which are particularly suited for influencing the flow in fluid-dynamical profile bodies. FIGS. 5A-5F show various arrangements of sound generators or sound transducers 52 to form an array 44 (phased array transducer). For details, please see reference [8] in the cited literature, which is incorporated herein by reference.

By using special transducers, the propagation direction of the acoustic wave can be adjusted in a targeted manner or can be concentrated and focused on one point if necessary. In the embodiments of FIGS. 5A-5F, the acoustic waves are generated using a plurality of individual transducers—a large number of individual sound transducers 52—arranged in a particular manner, depending on the respective application. Different arrays 64 of sound transducers 52 are shown in FIGS. 5A-5F. An arrangement of such transducers is altogether referred to as a “phased array transducer” 66, because the individual transducers must be driven in a phase-shifted manner in order to obtain a directed (overall) acoustic wave or a concentration/focusing, see reference [8].

Elongate virtual riblets 44 can again be formed by using strip-like arrays 64 and can be additionally adjusted in distance and height. This is more clearly shown in FIG. 6. FIG. 6 shows sound focused near the surface by means of the phased array transducer 66, the sound being concentrated to a single pressure node.

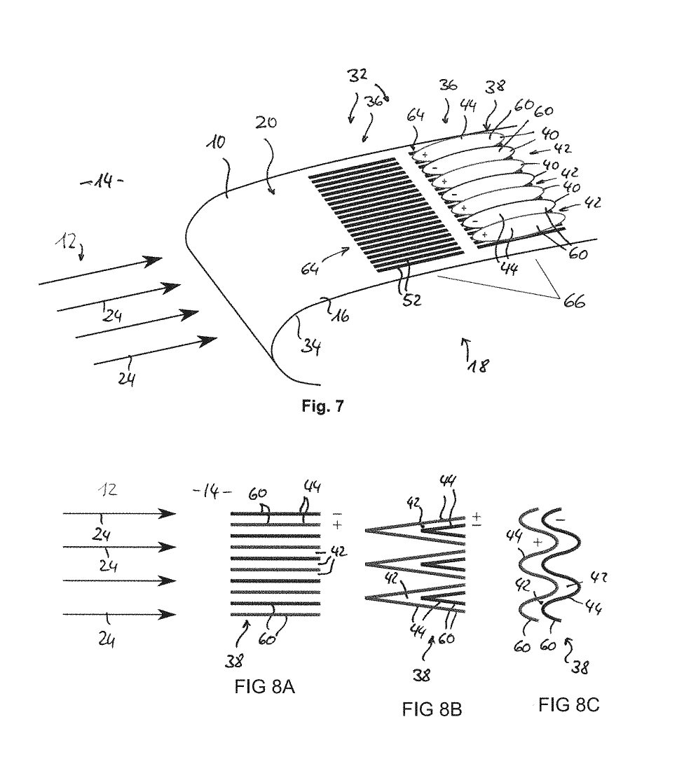

For influencing the flow, such phased array transducers 66 are arranged at regular intervals in the surface—fluid-dynamical surface 10—itself in order to form a plurality of such virtual riblets 44 on the surface. FIG. 7 shows a further exemplary embodiment of the fluid-dynamical profile body 34 including a further embodiment of the flow control device 32 that includes one embodiment of the acoustic wave generating means 36 in which such strip-like sound transducers 52 are combined into a phase array transducer 66 of such kind, for producing the virtual riblets 44.

FIG. 7 shows the generation of virtual riblets 44 by means of strip-like phased array transducers 66 on a fluid-dynamically effective surface 10.

In a further embodiment (not further illustrated) of the acoustic wave generating means 36, the individual transducers—sound transducers 52—are alternatively arranged in such a manner that when driven synchronously, the same already present a bundled radiation characteristic from the bare shaping thereof or by means of acoustic lenses. Such a configuration is currently less preferred as such arrays tend to be inflexible because they already present a fixed radiation direction or a fixed focus. Adjustments could be reached in this case by adjusting the position or orientation of the transducer or the acoustic lens. Depending on the respective case of use, these embodiments may also be interesting.

In general, ultrasound arrays are today's prior art and are thus known in other technical fields, for example in non-destructive material testing and in the destruction of tumor tissue or kidney stones or gallstones in the medical field. The adjustments for beam adaption and propagation of acoustic waves known in these technical fields can also be used for influencing flow as herein described.

Up to present, the virtual riblets 44 that are formed by antinodes of a standing acoustic wave and extend corresponding to the local distribution and position of the antinodes have been described as straight elements preferably extending parallel to the direction of flow. The riblets 44 are configured as a kind of pressure wall or sound wall 60—i.e., a wall of sound (baffle).

The form and orientation of the sound walls 60 need not necessarily be straight and parallel. Various other forms and distributions that can be generated using the phased array transducer 66 are also possible. Some exemplary arrangements are shown in FIGS. 8A-8C.

FIGS. 8A-8C show different possible ways of arranging the “virtual” riblets 44, namely a parallel arrangement in FIG. 8A, a tapering arrangement in FIG. 8B and a wave-like arrangement in FIG. 8C.

The conditions for optimal or maximal turbulence suppression can be determined in tests, depending on the respective application. Among others, in this case, self-optimization according to the principle of the neural networks is also conceivable, wherein the arrangement of the sound transducers is rather distributed statistically and the temporal generation and the shape of the sound nodes are determined towards a minimum drag by the self-learning process.

A further slightly modified use case is that breaking-out air vortices such as the so-called hairpin vortices, see reference [9], are blown in a targeted manner by means of a focused sonic pulse, which prevents their further formation. In this case, the transducer or sound transducer 52 can at the same time take the function of a sensor and an actuator, since in the opposite case, i.e., in the case of an existing pressure fluctuation, the transducer or sound transducer 52 converts the pressure fluctuation into an electrical signal serving for detecting the position of the vortices being created.

In addition to being used for flow manipulation, such sound walls 60 (baffles) can be used for other purposes, especially in the case of ultrasonic walls.

Wings that ice up during the flight, especially in the slat region, are a recurrent problem that is caused by approaching and adhering ice particles. By generating the virtual riblets 44, and by enveloping particular wing regions with the virtual riblets 44, the ice particles are deflected in a targeted manner. Accordingly, the sound walls 60 also function as a protective screen preventing adherence of ice.

Considering that acoustic waves also propagate in solid materials, such as aluminum, for example, the sound transducer 52 could be attached underneath the aircraft skin. The acoustic waves thus produced would penetrate through that material and into the overlying air layer.

To generally improve the coupling of the sound into a medium with a deviating acoustic impedance, matching layers are normally applied to the transducers. In the case of an aircraft, such a matching layer could be easily applied to the aircraft skin by coating, this without intrusion into the actual structure of the aircraft skin.

In the solutions herein described, “virtual” riblets 44 are generated by sound or, depending on the boundary conditions, by ultrasound. To generate the sound, in the presently preferred embodiment, phased array transducers 66 are used that are configured in a strip-like manner and are arranged longitudinally in the direction of flow 24.

By the phase-shifted driving of the individual sound transducers 52, a sound beam can be produced which generates a standing pressure wave in a manner focused close to the surface. This standing pressure wave acts as a wall 60 for the passing flow so that this wall 60 prevents the flow from passing and hence prevents or delays the transition from a laminar flow 22 to a turbulent flow 26.

A slightly modified embodiment not only provides that a transverse flow is prevented by means of virtual riblets 44, but also that the sound is focused in a targeted manner on air vortices breaking out, that these are blown and that further formation thereof is prevented.

Some advantages of the presented solutions are:
scalable sound walls 60 and hence adjustment to the situation of flow such as the flow velocity, starting/landing in the case of aircraft, especially when using phased array transducers 66;
a targeted manipulation of the flow, for instance in the case of breaking-out vortices;
generally, no surface-altering and hence flow-influencing intrusion into the surface structure.

The solutions presented herein particularly relate to
influencing the turbulence/manipulating the flow (manipulation of turbulence/flow)
actively changing the air drag (active air drag modification) and/or
generating an ultrasonic wall/sound wall (ultrasonic/sound wall).

The solutions as outlined above particularly provide an actuator system for influencing flows in order to reduce or increase drag.

Advantageous fields of application are in particular:

a reduction of air drag and hence fuel savings in aircraft and primarily in airplanes and in express trains

increasing the efficiency in turbines and wind power plants

improvements in any field of application where flows may assume a turbulent condition that leads to an increase in flow resistance.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 fluid-dynamical surface
12 flow
14 fluid medium
16 wing
18 passenger airplane
20 boundary layer
22 laminar flow
24 direction of flow
25 turbulent flow
28 transition region
30 laminar sub-layer
32 flow control device
34 profile body
36 acoustic wave generating device
38 standing acoustic wave
40 antinode
42 node
44 virtual riblet
46 wave to the right
48 wave to the left
50 standing wave
52 sound transducer
54 first sound transducer
56 second sound transducer
58 reflector
60 pressure wall/sound wall (baffle)
64 array
66 phased array transducer

1. A flow control device for influencing a flow of a fluid medium at a fluid-dynamical surface of a fluid-dynamical profile body, comprising a sound generating means for producing a standing acoustic wave with at least one of locally defined antinodes and nodes, or a locally defined focused sonic pulse.

2. The flow control device according to claim 1, wherein the acoustic wave generating device comprises at least one of:
a) at least one sound transducer to generate a first wave having a propagation direction which with its main directional component runs parallel to the surface and perpendicular to the direction of flow, and a sound reflecting device for back-reflecting the first wave for the purpose of generating a standing acoustic wave,
b) at least a first sound transducer to generate a first wave having a propagation direction which with its main directional component runs parallel to the surface and perpendicular to the direction of flow, and a second sound transducer to generate a second wave having a propagation direction opposed to the propagation direction of the first acoustic wave in order to generate the standing acoustic wave by a superposition of the first and the second waves,
c) an array of sound transducers that are arranged at regular intervals in the region of the surface and are configured to generate the standing acoustic wave with at least one of locally defined antinodes and nodes, or the locally focused sonic pulse, or
d) an arrangement of at least one sound transducer, several sound transducers or at least one acoustic lens.

3. The flow control device according to claim 1, wherein the acoustic wave generating means is configured to generate the standing acoustic wave in such a way that at least one of
e) the nodes or antinodes longitudinally extend along the direction of flow,
f) nodes and antinodes alternate in a transverse direction to the direction of flow,
g) locations of at least one of nodes or antinodes run in a plate-like or wall-like manner,
h) locations of at least one of nodes or antinodes run in at least one of a tapering or triangular fashion seen in a plan view of the surface,
i) locations of at least one of nodes or antinodes run in a wave-like fashion seen in a plan view of the surface, or
j) locations of at least one of nodes or antinodes run parallel.

4. A fluid-dynamical profile body, comprising a fluid-dynamical surface against or around which a flow of a fluid medium flows when in operation, comprising an acoustic wave generating device to generate a standing acoustic wave with at least one of antinodes and nodes arranged in a locally defined manner on the surface, or a sonic pulse focused in a locally defined manner.

5. The fluid-dynamical profile body according to claim 4, comprising a flow control device for influencing a flow of a fluid medium at a fluid-dynamical surface of the fluid-dynamical profile body.

6. The fluid-dynamical profile body according to claim 4,
configured as one of:
an airfoil of an aircraft,
a wing or tail unit body of an airplane,
an engine inlet body of an aircraft, or
rotor blades or propeller blades of an aircraft or a windmill.

7. A flow control method for influencing flow at a fluid-dynamical surface of a fluid-dynamical profile body, comprising:
influencing the flow via acoustic waves generated in a locally defined manner on the fluid-dynamical surface.

8. The flow control method according to claim 7, further comprising at least one of the steps:
a) generating at least one standing acoustic wave, or
b) focusing a sonic pulse on a to-be-influenced flow region.

9. The flow control method according to claim 8, wherein step a) includes at least one, several or all of the following steps:
e) generating the standing acoustic wave with at least one of nodes or antinodes longitudinally extending along the direction of flow;
f) generating the standing acoustic wave with at least one of nodes or antinodes alternating in a transverse direction to the direction of flow,
g) generating the standing acoustic wave with at least one of nodes or antinodes extending straight in a top view of the surface,
h) generating the standing acoustic wave with at least one of nodes or antinodes extending in at least one of a tapering or triangular fashion in a top view of the surface,
i) generating the standing acoustic wave with at least one of nodes or antinodes extending in a wave-like fashion in a top view of the surface, or
j) generating the standing acoustic wave with at least one of nodes or antinodes extending parallel in a top view of the surface.

10. The flow control method according to claim 7, further including the step of:
preventing or delaying a transition of a laminar flow to a turbulent flow by using a standing acoustic wave as at least one of an obstacle to or guide for the flow.

11. The flow control method according to claim 7, further including the step of:
modifying the acoustic wave generation in response to parameters of the to-be-influenced flow.

12. The flow control method according to claim 7, further including the step of:
detecting at least one parameter of the to-be-influenced flow and generating the acoustic waves in response to the detected parameters.

13. The flow control method according to claim 7, further including the step of:
using at least one sound transducer to generate the acoustic wave and as a detector for detecting a characteristic or parameter of the to-be-influenced flow.

14. A method of using at least one of a standing acoustic wave or a focused sonic pulse in a fluid medium for the purpose of at least one of influencing a flow of the fluid medium on a fluid-dynamical surface or preventing ice formation on the fluid-dynamical surface.
